(19) United States
(12) Patent Application Publication
(10) Pub. No.: US 2022/0185693 A1
(43) Pub. Date: Jun. 16, 2022

(54) SYNTHESIS OF TRANSITION METAL LAYERED OXIDE MATERIALS FOR BATTERY CATHODES

(71) Applicant: UT-Battelle, LLC, Oak Ridge, TN (US)

(72) Inventors: Jianlin Li, Oak Ridge, TN (US); Yaocai Bai, Oak Ridge, TN (US); Mengya Li, Oak Ridge, TN (US); David Wood, Oak Ridge, TN (US)

(21) Appl. No.: 17/548,838

(22) Filed: Dec. 13, 2021

Related U.S. Application Data
(60) Provisional application No. 63/124,917, filed on Dec. 14, 2020.

(51) Int. Cl. C01G 53/00; H01M 4/505; H01M 4/525; H01M 4/04; C01G 49/00

(52) U.S. Cl. CPC C01G 53/40; H01M 4/505; H01M 2004/027; H01M 4/049; C01G 49/0072; H01M 4/525

(57) ABSTRACT

An improved method of forming a transition metal layered oxide material for alkali-ion battery cathodes include combining an alkali-containing precursor and at least one transition metal precursor or other metal precursor at a low temperature of less than 100° C. to form a liquid eutectic alloy mixture. The mixture is then heated at a temperature between 300° C. to 500° C. to pre-calcinate the mixture, and subsequently the pre-calcinated mixture is subjected to a final calcination at a temperature of 500° C. to 1000° C. to obtain a crystalline oxide material. A P2-type or O3-type cathode may be formed with the layered oxide material, and a sodium-ion battery cell may include the so-formed P2-type or O3-type cathode.

### CROSS-REFERENCE TO RELATED APPLICATIONS

This application claims the benefit of U.S. Provisional Application 63/124,917, filed Dec. 14, 2020, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE DISCLOSURE

The present disclosure relates to synthesis of transition metal oxide cathode materials for alkali-ion batteries.

### BACKGROUND OF THE DISCLOSURE

The demand for layered transition metal oxide cathodes used in Li-ion batteries (LIBs) continues to rise due to the high energy density of these cathodes and their cycling performance against carbonaceous anodes. Considering the cost of raw materials, research and industrial focus on cathodes have both been shifting from cobalt-containing materials to low-cobalt and cobalt-free materials. However, despite the materials cost, synthesis cost and efforts for layered transition metal oxides cathode materials have also been a major concern in the battery manufacturing process. Conventional synthesis methods, such as solid-state and sol-gel synthesis have been widely applied in previous literature. However, scalable production using the above-mentioned methods usually ends up with impurities in the final materials and energy-intensive processing. Thus, it is important to develop novel material synthesis method to decrease the efforts and ensure purity and homogeneity of the final materials.

Besides LIBs, lower-cost energy storage technology such as sodium-ion batteries (SIBs) have also been promising due to the abundance of sodium in comparison to lithium in earth's crust. Despite the advantage, several challenges exist for SIBs including their lower energy density in comparison to LIBs and their unsatisfactory cycling life in full cell configurations. In a typical sodium-ion battery, transition metal oxide (TMO) cathodes and hard carbon anodes are utilized in the electrochemical cell. Among all types of cathode materials, transition layered metal oxide materials are preferred for SIBs due to their high energy density. Layered structure P2-type or O3-type cathodes in particular have attracted much interest in SIBs due to their peculiar crystalline orders ensured by the ABBAAB (P2) or ABCABC (O3) plane sequences along the crystalline c-axis, where Na-ions are located in prismatic or octahedral orientations between the TMO layered slabs. When compared to O3-type cathodes, P2-type cathodes have the following advantages: a) faster ion diffusion between neighboring prismatic sites through direct face-sharing facets; b) higher phase transition reversibility during sodium removal and uptake; and c) higher reversible capacities in sodium cells. The potential of P2-type cathodes in SIB cells has also been shown when they are paired with hard carbon in which hard carbon yielded reversible capacities over 250 mAh/g. However, conventional synthesis of P2-type cathodes such as solid-state or sol gel methods have often led to impure and inhomogeneous phase formation. These synthesis methods are not only non-scalable and impractical, but they also lead to disappointing electrochemical performance in the case of P2-cathodes. Further, conventional methods for synthesizing TMO layered oxide materials require energy-intensive powder-mixing processes and/or length rinsing steps, which adds to the production cost for these materials. Additionally, the resulting materials typically have inhomogeneous morphology as well as impurities after high temperature annealing. As a result, the actual capacities of these materials are far less than their theoretical values.

Accordingly, there remains a need for improved synthesis methods for cathode active materials used in alkali-ion batteries (LIBs, SIBs and so on) that is easily scalable and that results in high homogeneity, high crystallinity, and less impurity of the synthesized materials.

### SUMMARY OF THE DISCLOSURE

An improved method of forming a transition metal layered oxide material for alkali-ion battery cathodes is provided. A layered oxide material obtained by the method, a P2-type or O3-type cathode formed with the layered oxide material, and an alkali-ion battery cell including the P2-type or O3-type cathode are also provided. The method includes combining a alkali ion-containing precursor and at least one transition metal precursor or other metal precursor at a low temperature of less than 100° C. to form a liquid eutectic alloy mixture. The mixture is then heated at a temperature between 300° C. to 500° C. to pre-calcinate the mixture, and subsequently the pre-calcinated mixture is subjected to a final calcination at a temperature between 500° C. to 1000° C. to obtain a crystalline oxide material.

In certain embodiments, the alkali ion-containing precursor may be, but is not limited to, one or more of hydroxide, nitrate, sulfate and acetate compounds. Also, the at least one transition metal precursor may have the formula TMₓI_{y}.nH₂O wherein 0≤n≤9, TM is selected from manganese (Mn), iron (Fe), copper (Cu), chromium (Cr), titanium (Ti), zinc (Zn), cobalt (Co), nickel (Ni), and zirconium (Zr), and I is selected from carbonate, sulfate, nitrate and acetate. Further, the at least one other metal precursor may have the formula MₓI_{y}.nH₂O wherein 0≤n≤9, and M is selected from an alkali metal, an alkaline earth metal, and aluminum (Al). In some exemplary embodiments, the obtained layered oxide material may be NaₓFe_{1/2}Mn_{1/2}O₂ or NaₓNi_{1/2}Mn_{1/2}O₂.

The present method involves the formation of a binary, ternary, or even a quaternary eutectic alloy at the beginning of the synthesis of the transition metal layered oxide material. The eutectic alloy has a melting point lower than any of the individual precursors that are used to form the mixture. Therefore, depending on the physical properties of the precursors, the mixture can become a liquid at room temperature or without being heated to a high temperature. Further, uniform mixing is achieved at the atomic level during formation of the liquid eutectic mixture. The formed liquid eutectic mixture also has good stability and little to no phase separation. Also, after high temperature annealing in the calcination step, the obtained layered transition metal oxide material has homogeneous morphology, high crystallinity, and less impurities in comparison to TMO materials synthesized by solid-state or sol-gel methods. Additionally, the present method can be easily scaled up for high throughput at a low cost.

These and other features and advantages of the present invention will become apparent from the following detailed description of the invention, when viewed in accordance with the appended claims.

### DETAILED DESCRIPTION

A method of forming a transition metal layered oxide material for a sodium-ion battery cathode includes combining a sodium-containing precursor and at least one transition metal precursor or other metal precursor at room temperature, near room temperature (e.g. 20-40° C.), or other low temperature that is less than 100° C. to form a liquid eutectic alloy mixture. The mixture is then heated to pre-calcinate the mixture at a temperature between 300-500° C., and subsequently the pre-calcinated mixture is subjected to a final calcination at a temperature between 500° C. to 1000° C. to obtain a crystalline oxide material. In various embodiments, the sodium-containing precursor may be, but is not limited to, one or more of sodium hydroxide, sodium nitrate, and sodium acetate. The at least one transition metal precursor may have the formula TMₓI_{y}.nH₂O wherein 0≤n≤9, TM is selected from manganese (Mn), iron (Fe), cobalt (Co), nickel (Ni), and zirconium (Zr), and I is selected from nitrate, acetate, carbonate and sulfate. The at least one other metal precursor may have the formula MₓI_{y}.nH₂O wherein 0≤n≤9, and M is selected from an alkali metal, an alkaline earth metal, and aluminum (Al).

In some embodiments, the step of combining may include mixing the sodium-containing precursor and at least one transition metal precursor or other metal precursor with a mortar and pestle, and the precursors optionally may be mixed by hand. After the step of combining the precursors to form the eutectic mixture, the mixture may be heated to 105° C. for a period of hours to remove water prior to pre-calcination. The step of heating the mixture to pre-calcinate the mixture may be performed, for example, at a temperature of 400° C. in an alumina boat or other similar vessel. The pre-calcinated mixture may be subjected to grinding prior to the final calcination, and one or more of a nitrate or an acetate may be removed from the mixture during pre-calcination. The step of subjecting the pre-calcinated mixture to a final calcination may be performed for at least 12 hours.

In some embodiments, the layered oxide material obtained by the method may be a P2-type or a O3-type layered oxide. In certain exemplary embodiments, the obtained layered oxide material may be NaₓFe_{1/2}Mn_{1/2}O₂ or NaₓNi_{1/2}Mn_{1/2}O₂. A P2-type or O3-type cathode may be formed using the obtained layered oxide material, and a sodium-ion battery may include the P2-type or O3-type cathode.

In an exemplary embodiment of the method, sodium hydroxide (NaOH), iron nitrate nonahydrate (Fe(NO₃)₃.9H₂O), and manganese nitrate tetrahydrate (Mn(NO₃)₂.4H₂O), all from Sigma-Aldrich, were used as precursors for the synthesis of Na_{2/3}Fe_{1/2}Mn_{1/2}O₂. Eutectic alloy synthesis according to the present method was performed by mixing together appropriate amounts of the above precursors in a mortar and then transferring the mixture into a glass container inside an oven preheated at 40° C. Thereafter, the solid mixture turned into a uniform dark-brown liquid. The liquid mixture was dried overnight at 120° C. The resulting dry mixture was then pre-calcinated at 400° C., followed by a final calcination at 950° C. for 12 hours to obtain the transition metal oxide material. For comparison, sol-gel synthesis was performed by dissolving 8 g of Fe(NO₃)₃.9H₂O and 5 g of Mn(NO₃)₂.4H₂O in 300 mL of de-ionized water preheated at 100° C. in a beaker under continuous stirring. A NaOH solution was then added to the mixture followed by overnight drying at 120° C. The dry mixture was ground before pre-calcination at 400° C. for 6 hours to remove nitrates followed by annealing at 950° C. for 12 hours.

Morphology of the synthesized materials was analyzed using a scanning electron microscopy (SEM) (Zeiss Merlin) and the crystal data were collected on an X-ray diffractometer (X'pert Pro PANalytical). Inductively coupled plasma-optical emission spectroscopy (ICP-OES) was performed with an Optima 2100 DV spectrometer (PerkinElmer) to determine the chemical composition of the synthesized NaₓFe_{1/2}Mn_{1/2}O₂ materials.

The morphologies of NaₓFe_{1/2}Mn_{1/2}O₂ synthesized by the present eutectic alloy method (hereinafter referred to as “EA-P2”) and the sol-gel method (hereinafter referred to as “SG-P2”) were compared. Sol-gel synthesis produced mostly large particles over 10-15 microns in size composed of hexagonal plates and aggregates. In contrast, NaₓFe_{1/2}Mn_{1/2}O₂ synthesized by the eutectic-alloy method, exhibited much smaller platelets in the range of 1-2 microns within a porous microstructure. X-ray patterns of the SG-P2 and EA-P2 reveal P2-type phase NaₓFe_{1/2}Mn_{1/2}O₂ can be identified with all major diffraction lines matching previously observed peaks of P2-Na_{2/3}MnO₂. However, there were some impurities in the sol-gel SG-P2 sample, which could have been NaMnO₂ and NaFeO₂, that are due to a phenomenon known as atom-level segregation during the gelation process of mixed precursors. In contrast, the eutectic alloy method first involved a liquification process that enabled uniform and homogenous mixing at the atomic level, which yielded a highly pure and more crystalline phase. ICP results revealed that “x” values were approximately 0.7 and 0.6 for SG-P2 and EA-P2, respectively, which indicate that the phases formed were sodium deficient phases as expected for P2-type sodium-based cathodes.

To test the performance of the synthesized NaₓFe_{1/2}Mn_{1/2}O₂ materials, positive electrodes were fabricated by mixing 80 wt. % NaₓFe_{1/2}Mn_{1/2}O₂ powders, 10 wt. % polyvinylidene fluoride (PVDF) (Solvay 5130) and 10 wt. % carbon black (Super C65) in N-methyl-2-pyrrolidone (NMP) solvent. The slurry was then cast onto aluminum foil and dried overnight at 115° C. inside a dry room (0.1% relative humidity with a dew point of less than −50° C.). CR2032 coin cells were assembled with 14 mm disks of electrodes. Sodium metal was used as a counter electrode with a glass fiber separator (Whatman GF/F). The electrolyte was 1M NaClO₄ dissolved in propylene carbonate (PC) (Sigma-Aldrich) added with 5 vol % fluoroethylene carbonate (FEC) (Sigma-Aldrich).

Negative electrodes were fabricated by mixing 92 wt. % hard carbon powder (Kuranode, Kuraray), 6 wt. % PVDF (Kureha 9300) and 2 wt. % carbon black (Super C65) in NMP and then casting onto copper foil. Punched hard carbon electrodes were pre-sodiated in sodium metal cells that were discharged and charged three times between 0.01 and 3 V at a current density of 25 mA/g to determine the 100% state of discharge, followed by discharging to various state of discharge (0, 50, and 100% depth of discharge). The cells were then disassembled, and the hard carbon anodes were washed with PC and dried inside a glovebox before being assembled into full cells with the NaₓFe_{1/2}Mn_{1/2}O₂ cathodes. Full cells were cycled between 1.5 and 4.2 V at a current density of 13 mA/g_{cathode}.

Galvanostatic tests were performed between 1.5 and 4.3 V at a current density of 13 mA/g. Sodium half-cells including the P2-cathode went through a first cycle between 1.5 and 4.3 V before being subjected to the galvanostatic test using the galvanostatic intermittent titration technique (GITT). GITT was performed by (1) charging the cells for 2-hour to a certain state of charge, followed by (2) a 3-hour relaxation period. Steps (1) and (2) were repeated loop wise until the cell reached the upper cutoff voltage of 4.3 V. A similar test profile was used during the discharge of the cell to 1.5 V. Electrochemical impedance spectroscopy (EIS) was performed at the beginning of the charge/discharge process and at the end of each loop after relaxing the cell for three hours, in the frequency range from 200 kHz to 0.1 Hz using a sinusoidal voltage amplitude of 10 mV. The obtained EIS spectra were fitted using an equivalent circuit model built with ZView software in order to extract resistance values associated with the electrochemical processes.

The electrochemical charge/discharge and cycling of the SG-P2 and EA-P2 compounds against a sodium metal anode resulted in SG-P2 NaₓFe_{1/2}Mn_{1/2}O₂ delivering an initial reversible capacity of 173 mAh/g. Upon charging, three major voltage regions were observed and assigned to the following redox activities in agreement with literature: 1) Mn^{3+/4+} redox activity below 3.0 V; 2) Fe^{3+/4+} redox activity between 3.0 and 4.0 V; and 3) oxygen anion redox reaction above 4.0 V. In comparison, EA-P2 NaₓFe_{1/2}Mn_{1/2}O₂ exhibited a higher initial reversible capacity of 188 mAh/g due to an improved Mn^{3+/4+} redox process. The cycling performances against sodium metal of SG-P2 and EA-P2 showed that EA-P2 and SG-P2 retained about 150 mAh/g capacity after completion of 20 cycles. These similar trends of capacity retention in sodium cells for both EA-P2 and SG-P2 can be attributed to the following reasons: 1) high reactivity of sodium metal with the electrolyte upon cycling; and/or 2) structural distortion and phase transitions. These two possible reasons, especially sodium metal reactivity, could have contributed to altering the benefit of the higher initial capacity obtained in the case of the EA-P2 material. Therefore, it was found that coupling these materials against realistic anodes such as hard carbon was a better indicator of their cycling performances as discussed below.

Thereafter, kinetic studies using GITT and EIS were performed to measure the Na-ion diffusion values for the NaₓFe_{1/2}Mn_{1/2}O₂ materials prepared by sol-gel and eutectic methods. Na-ion diffusion coefficients were calculated using the following equation (1):

$$D = \frac{{L}^{2}}{τ} \qquad ( 1 )$$

where L (diffusion length) was averaged from cross-section SEM images and τ (relaxation time) was derived from the fitting of the voltage depolarization using the following equation (2):

$$L n ( {U}_{0} - {U}_{∞} ) = L n A + \frac{8 t}{{π}^{2} τ} \qquad ( 2 )$$

where A is the constant term for a particular material, and U(t) and U(t=∞) are the cell voltage at times t and t(∞). The slope of the plot ln(U(t)−U(t=∞)) vs. t provides the relaxation time τ. The diffusion kinetics for Na⁺ in the P2 material were slightly improved by the EA method in comparison with the SG method, with an average D_{Na+} of 1.83×10⁻¹³ cm²/s and 1.60×10⁻¹³ cm²/s upon charge and discharge, respectively. The average diffusion coefficient values for the SG-P2 material were 1.61×10⁻¹³ cm²/s (D_{Na+} charge) and 1.56×10⁻¹³ cm²/s (D_{Na+} discharge). The overall improved Na⁺ diffusion kinetics in the case of the EA-P2 material can be attributed to improved crystallinity, uniform diffusion length, and absence of impurities. This observation is also consistent with the improved capacities associated with the Mn^{3+/4+} and Fe^{3+/4+} redox couples between 1.5 and 4V in the case of the EA-P2 NaₓFe_{1/2}Mn_{1/2}O₂. At the end of the charge/discharge, a slightly decreased D_{Na+} was observed which could be due to the sliding of MnO₂ slabs that leads to octahedral Na⁺ vacancies.

The measured impedance spectra of the SG-P2 and EA-P2 samples consist of two semicircles in the medium frequency range followed by Warburg impedance spikes in the lower frequency range. The high frequency intercept is due to the Ohmic resistance of liquid electrolyte along with a minor contribution of the solid electrolyte interface (SEI) layer. The Ohmic resistance (Rₛ) for each cell remained approximately the same as a function of the states of charge (SOCs). However, the SG-P2 sample exhibited higher Rₛ (˜20Ω) compared to the EA-P2 sample (˜4Ω) even though the same electrolyte was used for these two cathodes. The difference in Rₛ values for SG-P2 and EA-P2 cathodes may be attributed to: 1) microstructure and larger particles of SG-P2 in the composite electrode leading to a higher tortuosity in comparison with the EA-P2 composite electrode; and 2) reaction between electrolyte and impurities leading to a more ionically resistive SEI layer.

Charge transfer resistance at the electrolyte/Na metal interface (R_{ct1}) is influenced by SEI formation at the metal anode surface. Upon charging/discharging, the SEI layer becomes more resistive due to electrolyte decomposition. Thus, R_{ct1} values for the SG-P2 cathode continuously increased upon charge and discharge. However, R_{ct1} for the EA-P2 cathode was higher initially but continuously decreased upon charging and discharging. This phenomenon indicates that a more reversible SEI can be formed at the electrolyte/Na metal anode for EA-P2 compared to SG-P2. However, it could also be due to the nature of the Na metal surfaces as these can be affected by the manual rolling of the metal. As for the charge transfer resistances at the cathode/electrolyte interface (R_{ct2}), the resistance values for both the electrodes (SG-P2 and EA-P2) gradually decreased upon sodiation due to the formation of mixed valence states which enhanced the electronic conductivity of active particles and reduced interfacial resistance. The observed differences of R_{ct2} between SG-P2 and EA-P2 may also be induced by the presence of impurities within the SG-P2 cathode. It is also possible that the smaller particle sizes of EA-P2 contributed to lowering R_{ct2} over the whole range of charge/discharge. Moreover, R_{ct2} for EA-P2 exhibited minimal changes in the charge-discharge cycle. However, R_{ct2} values for SG-P2 were higher during discharge than charge, which indicates that a resistive interface may have formed for the SG-P2 electrode within a cycle. In addition, the larger particle sizes of SG-P2 may result in a less active electrochemical interface compared to EA-P2 which can further lead to higher interfacial resistance in the case of SG-P2.

Further, it is important to evaluate a sodium-metal-free cell to assess the cycling performance of new cathode materials. In this case, hard carbon (HC) was used which was first tested against a sodium metal anode, and the results showed that HC generated 250 mAh/g reversible capacity. Cells were then fabricated with the EA-P2 cathode and hard carbon anode. The cycling of the cells containing non-sodiated hard carbon anodes resulted in a poor reversible capacity of only 80 mAh/g. However, by electrochemically pre-sodiating hard carbon to 50% DOD, the cell displayed improved capacity. In this case, a reversible capacity of 163 mAh/g was achieved, which is two times higher than that of the cell assembled against pristine hard carbon. The pre-sodiation level of HC was also increased to 100%. This cell was first discharged to fill in the Na⁺ vacancies in P2-type layered cathodes, resulting in a capacity of 55 mAh/g. On charge and discharge thereafter, the cell reversible capacity increased to 182 mAh/g. Distinct voltage plateaus corresponding to Mn^{3+/4+} and Fe^{3+/4+} redox couples were observed. This cell configuration guaranteed a sufficient Na⁺ reservoir in HC to supply the Na-deficient P2 cathode, which led to improved reversible Na⁺ transport between the P2-NaₓFe_{1/2}Mn_{1/2}O₂ cathode and hard carbon anode.

Cycling performances of these P2-NaₓFe_{1/2}Mn_{1/2}O₂/HC cells were compared. In the case of non-sodiated hard carbon, the cell exhibited faster capacity fading with only 26% capacity retention over 50 cycles, which can be attributed to both the lack of enough Na⁺ to compensate for the vacancies in P2-type cathodes, and the continuous consumption of Na⁺ upon cycling. The removal of Na⁺ from the Na-deficient P2-cathode can result in impoverishing Na⁺ in the cathode, leading to irreversible structural distortion. The pre-sodiation of hard carbon anodes using sodium metal as discussed above resulted in higher reversible capacity and better capacity retention of 48% for the cell made of P2-cathode and 50% pre-sodiated HC. Most importantly, the cell that included the fully sodiated hard carbon (100% DOD) achieved the highest capacity retention of 64%. This sodium-metal-free system helped in mitigating the issue of reactions between sodium metal and electrolyte that causes electrolyte decomposition and excessive capacity fade. Indeed, a reversible Na⁺ transport can be realized between the fully-sodiated hard carbon anode and the Na-deficient P2-NaₓFe_{1/2}Mn_{1/2}O₂ cathode. However, even in the presence of HC the P2-cathode still showed capacity fading on cycling which likely was due to other issues such as electrolyte instability, P2-cathode layer collapse, SEI stability, and cell design.

The present eutectic synthesis method yields highly pure transition metal oxide materials with improved crystallinity and microstructure for potential application as high capacity cathodes for SIBs. In comparison with the sol-gel process, the present eutectic method improves Na⁺ kinetics at the cathode/electrolyte interface and enhances the Na⁺ diffusion coefficient. The present method also offers a scalable and highly efficient synthesis approach for transition metal oxide materials. The cathode materials synthesized by the present method were coupled with pre-sodiated hard carbon anodes to assess their cycling performances in practical cells. When assembled with fully pre-sodiated hard carbon, the cathode formed with the synthesized transition metal oxide delivered 182 mAh/g reversible capacity and achieved 64% capacity retention over 50 cycles owing to the enhanced structural stability of the cathode ensured by the excess of Na⁺ on the anode side, thereby maximizing cell energy density and performance. Based on the experimental results, it is believed that the present method may play a role in the emergence of practical sodium ion batteries.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of forming a transition metal layered oxide material for an alkali-ion battery cathode, the method comprising:
combining an alkali-containing precursor and at least one metal precursor at a temperature of less than 100° C. to form a liquid eutectic alloy mixture;
heating the mixture to pre-calcinate the mixture at a temperature between 300° C. to 500° C.; and
subjecting the pre-calcinated mixture to a final calcination at a temperature between 500° C. to 1000° C. to obtain a crystalline oxide material.

2. The method of claim 1, wherein the alkali-containing precursor is selected from the group consisting of alkali hydroxide, alkali nitrate, and alkali acetate.

3. The method of claim 1, wherein the at least one metal precursor is a transition metal precursor having the formula TMₓI_{y}.nH₂O wherein 0≤n≤9, TM is selected from manganese (Mn), iron (Fe), copper (Cu), chromium (Cr), titanium (Ti), zinc (Zn), cobalt (Co), nickel (Ni), and zirconium (Zr), and I is selected from nitrate, acetate, carbonate and sulfate.

4. The method of claim 1, wherein the at least one metal precursor has the formula MₓI_{y}.nH₂O wherein 0≤n≤9, and M is selected from an alkali metal, an alkaline earth metal, and aluminum (Al).

5. The method of claim 1, wherein the step of combining includes mixing the alkali-containing precursor and at least one metal precursor with a mortar and pestle.

6. The method of claim 5, wherein the precursors are mixed by hand.

7. The method of claim 1, wherein the pre-calcinated mixture is subjected to grinding prior to the final calcination.

8. The method of claim 1, wherein one or more of nitrate, carbonate, sulfate, and acetate is removed during pre-calcination.

9. The method of claim 1, wherein the step of subjecting the pre-calcinated mixture to a final calcination is performed for at least 12 hours.

10. The method of claim 1, wherein the step of heating the mixture to pre-calcinate the mixture is performed at a temperature of 400° C.

11. The method of claim 1, wherein the cathode is a layered oxide material.

12. The method of claim 1, wherein the obtained layered oxide material is a P2-type or a O3-type layered oxide.

13. A P2-type cathode formed with the layered oxide material of claim 12.

14. A sodium-ion battery cell including the P2-type cathode of claim 13.

15. The sodium-ion battery cell of claim 14, including a pre-sodiated hard carbon anode paired with the P2-type cathode.

16. An O3-type cathode formed with the layered oxide material of claim 12.

17. A sodium-ion battery cell including the O3-type cathode of claim 16.

18. The sodium-ion battery cell of claim 17, including a pre-sodiated hard carbon anode paired with the O3-type cathode.
